(19) United States
(12) Patent Application Publication
(10) Pub. No.: US 2026/0169706 A1
(43) Pub. Date: Jun. 18, 2026

(54) METHOD AND APPARATUS WITH CODE RETRIEVAL

(71) Applicant: Samsung Electronics Co., Ltd., Suwon-si (KR)

(72) Inventors: Do-Ha HWANG, Suwon-si (KR); Jiaxu LI, Suwon-si (KR); YunHao ZHANG, Suwon-si (KR); Jongseok KIM, Suwon-si (KR); Jihye KIM, Suwon-si (KR)

(73) Assignee: Samsung Electronics Co., Ltd., Suwon-si (KR)

(21) Appl. No.: 19/240,623

(22) Filed: Jun. 17, 2025

(30) Foreign Application Priority Data
Dec. 13, 2024 (KR) 10-2024-0186076

(51) Int. Cl. G06F 8/35; G06F 16/334

(52) U.S. Cl. CPC G06F 8/35; G06F 16/3344

(57) ABSTRACT

A processor-implemented method including receiving a natural language (NL) query, retrieving a similar code similar to the NL query from a database (DB) storing one or more codes and respective code descriptions for the one or more codes, generating input data based on one or more of the similar code and a code description corresponding to the similar code, and generating a final code based on the input data.

### CROSS-REFERENCE TO RELATED APPLICATIONS

This application claims the benefit under 35 USC § 119(a) of Korean Patent Application No. 10-2024-0186076, filed on Dec. 13, 2024, in the Korean Intellectual Property Office, the entire disclosure of which is incorporated herein by reference for all purposes.

### BACKGROUND

### 1. Field

The following description relates to a method and apparatus with enhanced code retrieval.

### 2. Description of Related Art

Recently, generative artificial intelligence (AI) including ChatGPT has been widely used in code development tasks such as code generation and code description generation. Generative AI receives instructions formed in a natural language (NL) as an input and generates code. When related code is provided as a reference input during this process, the code may be generated with a higher accuracy. A technology of Retrieval-Augmented Generation (RAG) may be used to retrieve code related to the code generation. RAG may improve performance in various data retrieval and generation tasks by retrieving reference data with a high similarity in a data storage and providing the reference data to generative AI.

However, the code and the NL have different modalities (bimodal), and while the NL is optimized for communication, the code itself is typically composed of a formalized language for computer execution. This modality difference may result in a lower accuracy compared to NL-based retrieval. In order to account for typical lower accuracy, a method to improve retrieval performance is desired where the method may generate an NL description for code using a high-performance language model (e.g., large language model (LLM)) and comparing it with NL instructions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including receiving a natural language (NL) query, retrieving a similar code similar to the NL query from a database (DB) storing one or more codes and respective code descriptions for the one or more codes, generating input data based on one or more of the similar code and a code description corresponding to the similar code, and generating a final code based on the input data.

The one or more codes and the respective code descriptions for the one or more codes may be aligned according to one of operation characteristics and a structural similarity of a corresponding code.

The retrieving of the similar code may include retrieving a suitable code description by calculating similarities between a vectorized NL query and the respective code descriptions.

The method may include evaluating a semantic relationship between the suitable code description and the NL query.

The generating of the final code may include generating a code obtained by extending or transforming the input data to correspond to the NL query.

The method may include performing verification for the NL query, the input data, and the final code.

The respective code descriptions for the one or more codes may be generated using a large language model (LLM) to be matched with the one or more codes as a pair.

The LLM may be trained to generate an NL-based description, the NL-based description reflecting a result of analyzing contextual characteristics of a code.

The receiving of the NL query may include rewriting the NL query in a form understandable by a retriever based on an LLM.

In a general aspect, here is provided a processor-implemented method including receiving a coding query generated based on a code input, retrieving a similar code similar to the coding query from a database (DB) storing one or more codes and respective code descriptions for the one or more codes, generating input data based one or more of the similar code and a code description corresponding to the similar code, and generating a final code description based on the input data.

The receiving of the generated coding query may include rewriting the code input into a form comprehensible to a retriever based on a large language model (LLM).

The generating of the final code description may include generating a code description obtained by modifying the input data to correspond to the coding query.

In a general aspect, here is provided an electronic device including a processor configured to execute instructions, a memory storing the instructions, and an execution of the instructions configures the processor to receive a natural language (NL) query, retrieve a similar code similar to the NL query from a database (DB) storing one or more codes and respective code descriptions for the one or more codes, generate input data based on at least one of the similar code or a code description corresponding to the similar code, and generate a final code based on the input data.

The electronic device may include an output device configured to display an interface related to code retrieval to receive the NL query.

The processor may be further configured to retrieve a suitable code description by calculating similarities between a vectorized NL query and the respective code descriptions, the one or more codes and the respective code descriptions for the one or more codes may be aligned according to one or more of operation characteristics and a structural similarity of a corresponding code.

The processor may be further configured to evaluate a semantic relationship between the suitable code description and the NL query.

The processor may be further configured to generate a code obtained by modifying the input data to correspond to the NL query.

The processor may be further configured to perform verification for the NL query, the input data, and the final code.

The respective code descriptions for the one or more codes may be generated using a large language model (LLM) to be matched with the one or more codes as a pair.

The LLM may be trained to generate an NL-based description, NL-based description reflecting a result of analyzing contextual characteristics of a code.

Other features and aspects will be apparent from the following detailed description, the drawings, and the claims.

### BRIEF DESCRIPTION OF THE DRAWINGS

FIG. 1 illustrates an example method of enhancing code retrieval performance according to one or more embodiments.

FIG. 2 illustrates an example method of enhancing code retrieval performance according to one or more embodiments.

FIG. 3 illustrates an example method of enhancing code description retrieval according to one or more embodiments.

FIG. 4 illustrates an example method of enhancing code description retrieval according to one or more embodiments.

FIG. 5 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

When a related code is included as input data of generative artificial intelligence (AI) when the AI is used to generate a code, a code with a higher accuracy and quality may be generated using a generative AI technology (e.g., a large language model (LLM)). Retrieval-Augmented Generation (RAG) may be used in the process of retrieving such a code, and RAG may support a code generation process by retrieving a suitable reference code from a data storage and providing the reference code as input to the generative AI.

A natural language (NL) is a language designed for communication between humans, a code is a structured language for computer execution, and these have different modalities (bimodal). Due to these different modalities, retrieval accuracy between the NL and the code may be lower than retrieval accuracy between NLs. To overcome this problem, a method of generating an NL description for a code using a high-performance language model (e.g., LLM) with increased retrieval efficiency through examples of this method will be described in greater detail below.

Therefore, in examples herein, a method of increasing retrieval performance and usability of generative AI by enhancing linkage between a code and a code description will be described.

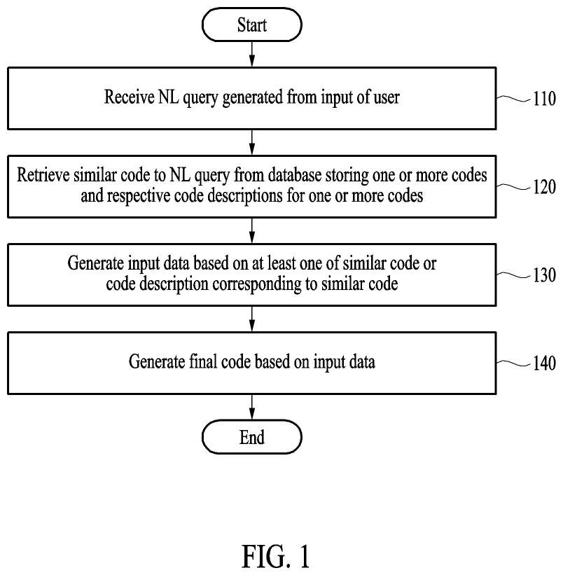

FIG. 1 illustrates an example method of enhancing code retrieval performance according to one or more embodiments.

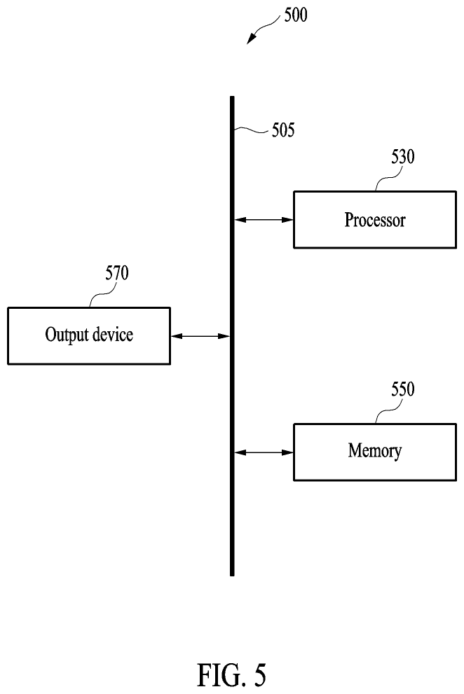

For ease of description, it is described that operations 110 to 140 may be performed by an electronic device 500 illustrated in FIG. 5. However, operations 110 to 140 may be performed by other suitable electronic devices in suitable systems.

Furthermore, the operations of FIG. 1 may be performed in the order and manner as illustrated. However, the order of some operations may be changed or omitted without departing from the spirit and scope of the shown example. The operations shown in FIG. 1 may be performed in parallel or simultaneously.

Referring to FIG. 1, in a non-limiting example, in operation 110, an electronic device (e.g., electronic device 500) may receive an NL query generated from an input of a user. Since the input of the user is generally formed of an NL, the electronic device may transform the input of the user into NL queries. Since the input of the user may be unclear, the electronic device may refine this input and transform the input into a processable NL query.

In an example, the electronic device may additionally use an LLM when transforming the input of the user into the NL query. The electronic device may rewrite the input of the user into an NL query in a form that is easily understanded by a retriever based on the LLM. That is, the input is rewritten to be understandable by or comprehensible to the retriever based on the LLM's NL capabilities. In another example, where the input is referred to simply as a NL query, the NL query may be rewritten to be understandable by or comprehensible to the retriever. Herein, the electronic device may access a cloud-based LLM through a network or use an LLM implemented in an on-device form on the electronic device.

For example, when a user inputs a command such as “Generate a code that implements a user login function,” the electronic device may analyze this and transform it into a more specific and clearer NL query, such as “Code that processes a user authentication and login process.” This command from the user may be referred to or include a NL request to generate code, a code generation request, or a code description, for example.

The LLM may analyze context and intent to provide an NL query that is modified into a form processable by the retriever even when the input of the user is ambiguous or incomplete. In an example, the electronic device may generate input data required to derive more accurate and suitable retrieval results to enable the LLM to contextualize the NL query.

In an example, in operation 120, the electronic device (e.g., electronic device 500) may retrieve a code that is similar to the NL query from a database (DB) storing one or more codes and respective code descriptions for the one or more codes. The DB may include the one or more codes and the code description for each code, and the codes may be stored in pairs with respective related code descriptions. The one or more codes and the respective code descriptions for the one or more codes may be aligned according to operation characteristics or a structural similarity of a corresponding code.

The respective code descriptions for the one or more codes may be generated using a high-performance language model (e.g., LLM) and matched in pairs with the one or more codes. The high-performance language model (e.g., LLM) may generate an NL-based description that reflects a result of analyzing contextual characteristics of a code.

In an example, the electronic device may retrieve a suitable code description by calculating similarities between a vectorized NL query and the code descriptions by a predetermined method. The electronic device may vectorize the NL query and compare the NL query with the code descriptions in the DB. Vectorization may be a task of transforming representation of two sets of data into the same space so as to calculate a similarity between an NL query and a code description. For example, when the user inputs a query such as “Retrieve a code that implements a user authentication system,” the electronic device may vectorize this and calculate similarities with the code descriptions stored in the DB.

The electronic device may evaluate the similarities between the vectorized NL query and the code descriptions using dot product similarity, cosine similarity, or other predetermined mathematical methods to retrieve a most suitable code description. For example, a code description including keywords and contextual information related to “user authentication” may have a high similarity.

More specifically, the retriever may retrieve a suitable code by calculating the similarity between the NL query and the code description stored in the DB. The retriever may compare the NL query with the code descriptions stored in the DB.

By vectorizing the NL query, the retriever may be able to compare the vectorized NL query with the code descriptions in the DB in the same vector space. This process may be performed through an NL processing (NLP) technology and a machine learning model. In addition, when the code descriptions in the DB are vectorized or previously vectorized, the comparison between the NL query and the code descriptions may be performed efficiently.

In an example, the retriever may use a variety of predetermined methods to calculate the similarity.

For example, the electronic device may use various mathematical methods to evaluate the similarity between the NL query and the code descriptions stored in the DB. Dot product is one such method that may calculate a similarity based on vector representations of the coding query and the code descriptions. The dot product considers both a magnitude and a direction of a vector, and thus, it may be useful to evaluate relevance of the NL query and the code description in a case where the magnitude is important.

For example, when the user requests “Description for a user authentication system,” the electronic device may vectorize the NL query and retrieve a description with a highest similarity by calculating the dot product with a code description vector stored in the DB.

The dot product may help the retriever efficiently calculate the similarity between the coding query and the code description in the DB. In addition, the dot product may also be used with cosine similarity to contribute to evaluation of the similarity more accurately. This combination may allow the electronic device to retrieve an accurate and highly relevant code description that matches a user query and use the code description as input data.

For example, the cosine similarity may evaluate a similarity by calculating an angle between the vectorized NL query and the code description. The smaller the angle, the higher the similarity. The Euclidean distance may measure a distance value between the NL query and the code description in a vector space to calculate a close result. For a scoring-based model, a pretrained language model may be trained with a relationship between the NL query and the code description to apply a score.

For example, when the user inputs an NL query such as “Retrieve a code for processing a login process,” the retriever may compare the vectorized query with the code descriptions within the DB. A code description including a keyword such as “user authentication” or “login procedure” and having a high similarity may be selected preferentially.

In an example, the electronic device may evaluate a semantic relationship between the retrieved code description and the NL query. Retrieval results may be aligned according to similarity scores, and a code that is most suitable with a code required by the user may be returned as a top result. In addition, the retriever may perform semantic analysis to secure semantic consistency between the retrieved code description and the NL query. For example, when the retrieved code description is directly related to the intent of the query, such as “processing of a login process,” the corresponding code description may be selected preferentially. Through this, the electronic device may retrieve and output a code that matches the intent of the user.

In an example, in operation 130, the electronic device (e.g., electronic device 500) may generate input data based on at least one of the similar code or a code description corresponding to the similar code. The similar code may be retrieved by the retriever based on the NL query of the user, and the code description may be formed of an NL that represents operation characteristics and contextual information of the retrieved code.

In an example, the electronic device may form input data by combining the retrieved code and the code description. The retrieved code may be used in a code generation task, and the code description may be additionally used to supplementarily provide the operational purpose and intended use of the code. For example, when the user inputs a query such as “Generate a code for processing user authentication,” the electronic device may form input data along with an existing code related to the user authentication and a description of a corresponding code (e.g., “Process for verifying a user input and verifying qualification in a DB”).

In addition, when forming the input data, the electronic device may generate the input data by using only the retrieved code even if the retrieved code description does not exist. In this case, a code LLM may generate a new code based on a structure and an operation pattern of the existing code due to the lack of the code description.

In an example, the electronic device may include the user query in the input data so that the code LLM simultaneously considers the retrieved code and description and the user intent. For example, the input data may be transmitted to the code LLM in a format such as “Query: Code for processing user authentication, Retrieved code: [Existing code content], Description: User input verification and qualification verification.”

The electronic device according to an example may form the input data by removing unnecessary information or duplicate data during the process of forming the input data. Through this, the code LLM may generate a final code that matches the user query by using information about the retrieved code and description.

In an example, in operation 140, the electronic device (e.g., electronic device 500) may generate the final code based on the input data. The code LLM may output the final code that satisfies the request of the user by using the input data. The electronic device may execute the code generation process through the code LLM, and the code LLM may generate a most suitable code result by analyzing information and context provided in the input data.

In an example, the electronic device may generate a code obtained by extending or transforming the input data to correspond to the NL query. At this time, the electronic device may generate the code through the code LLM. The electronic device may access a cloud-based code LLM through a network or use a code LLM implemented in an on-device form on the electronic device. For example, when the user inputs a query such as “Generate a code for processing user authentication,” the electronic device may form the retrieved code and the corresponding code description as the input data and transmits the input data to the code LLM. The code LLM may generate “Code for verifying a user input and verifying qualification in a DB to generate a session” based on this data.

In an example, the electronic device may perform verification for the NL query, the input data, and the final code. In the verification process, the electronic device may confirm whether the generated code matches the intent of the user query, and evaluate whether the code may be executed, perform error detection, determine an operation relevance, or the like.

The verification may be performed using a lightweight verification model or an additional language model. For example, it may be confirmed whether the generated code “including user input verification and DB inquiry in a login procedure” coincides with the user query. In addition, an expected result may be derived using sample data for testing the operation of the code.

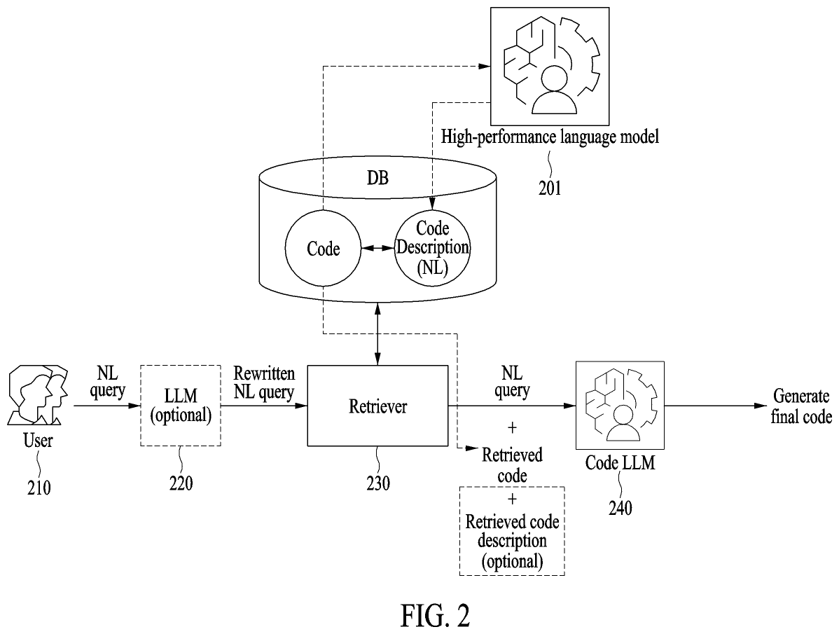

FIG. 2 illustrates an example method of enhancing code retrieval performance according to one or more embodiments.

The description provided with reference to FIG. 1 may apply to FIG. 2, and any repeated description related thereto may be omitted.

Referring to FIG. 2, in a non-limiting example, a user 210 may input an NL query, such as a code generation request. The NL query input by the user 210 may be rewritten by an LLM 220, if necessary. The rewritten NL query may be compared with a suitable item among codes and code descriptions stored in a DB by a retriever 230, and the DB may include paired data of a code and a code description configured through a high-performance language model (e.g., LLM) 201.

The high-performance language model (e.g., LLM) 201 may generate a code (e.g., Snippet) and a suitable description thereof in the DB using an LLM such as Llama3.1-405B, and form a pair of the code and the code description. Such a DB may be aligned based on operation characteristics and a structural similarity of code to increase the retrieval accuracy and efficiency.

In an example, the retriever 230 may retrieve a most suitable code by calculating a similarity between the NL query and the code description in the DB. For example, when the user inputs a query such as “Generate a code that implements a user authentication system,” the retriever may retrieve a related code and code description and generate input data to be transmitted to a code LLM 240.

More specifically, the retriever 230 may process the NL query input from the user 210 and retrieve the most suitable code by comparing the processed NL query with the codes and code descriptions stored in the DB. The retriever 230 may calculate the similarity between the code descriptions stored in the DB and the NL query to perform the retrieval task, thereby deriving the suitable code and code description.

The retriever 230 may perform a vectorization process to compare the NL query with the code descriptions within the DB. When the user inputs the NL query such as “Generate a code that implements a user authentication system,” the retriever may transform the NL query into a representation in a vector space. When the code description stored in the DB is also vectorized in advance, the similarity between two vectors may be compared in the same vector space.

For example, when the user inputs the NL query that includes a request of “user authentication system,” the retriever may perform the following tasks of:
i) vectorizing an NL query into a representation comparable to a code description; ii) retrieving items with contextually relevant descriptions, such as “User input verification,” “Verification of qualification,” and “Generate a session,” within the code description in the DB; and iii) calculating similarity scores and selecting a code and code description with a highest score. For example, a code description that covers “user authentication” and “login procedure” may show a high similarity.

The retriever 230 may output input data to be transmitted to the code LLM 240 based on the retrieved code and code description. The input data may include the code description and the user query along with the retrieved code itself. The input data may cause the code LLM 240 to generate a final code that satisfies the request of the user.

The code LLM 240 may generate the final code based on the input data including the retrieved code and code description received from the retriever 230 and the user query. The generated code may be a high-quality code that considers the request of the user and the context, and the electronic device 500 may also perform verification of the generated code if necessary.

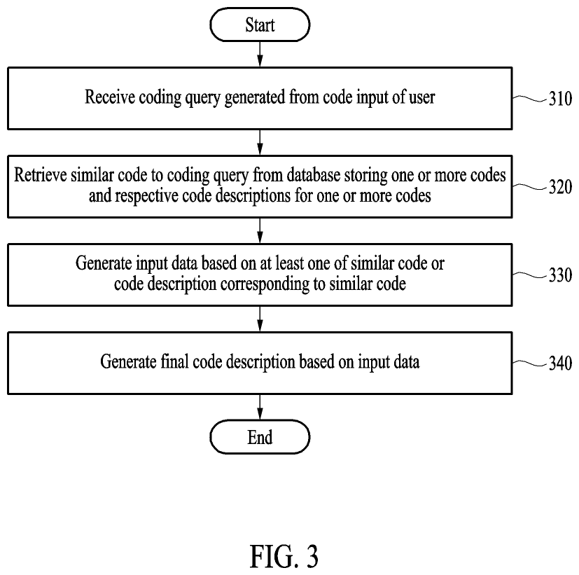

FIG. 3 illustrates an example method of enhancing code description retrieval according to one or more embodiments.

The description provided with reference to FIGS. 1 and 2 may apply to FIG. 3, and any repeated description related thereto may be omitted.

For ease of description, it is described that operations 310 to 340 are performed by the electronic device 500 illustrated in FIG. 5. However, operations 310 to 340 may be performed by another suitable electronic device in a suitable system.

Furthermore, the operations of FIG. 3 may be performed in the order and manner as illustrated. However, the order of some operations may be changed or omitted without departing from the spirit and scope of the shown example. The operations shown in FIG. 3 may be performed in parallel or simultaneously.

Referring to FIG. 3, in a non-limiting example, in operation 310, an electronic device (e.g., electronic device 500) may receive a coding query generated from a code input of a user. The user may input a code to inquire about a function of the code or request a description related to the code. That is, the input code may be a computer code or a fragment of computer code for which the user is seeking to receive the above described feedback or analysis. The electronic device may analyze a coding query for the code input of the user and transform the coding query into a processable NL-based coding description query.

In an example, the electronic device may rewrite the code input of the user in a form that is easily understanded by the retriever based on the LLM. At this time, the LLM may write a code description for the code input of the user in the NL to generate a rewritten coding query in the NL. The LLM may analyze the context and the intent of the code input by the user and write the code description in the NL. The LLM may generate an NL query that describes operation purpose and structural characteristics of the code, and a problem to be solved by the code.

For example, when the user inputs a “code for initializing a login system,” the electronic device may analyze this through the LLM and transform it into an NL-based description, such as “this code performs user login initialization, verifies qualification, and starts a session.”

In another example, the LLM may understand contextual characteristics of the code and write an NL description even when the code input of the user is ambiguous or incomplete. For example, when the input code is brief, such as “Encrypt user information,” the LLM may rewrite it into a more specific description, such as “To protect user data through an encryption algorithm to prevent data leakage.”

The electronic device may be configured to transmit the NL description query provided by the LLM to the retriever to retrieve a suitable code description and related data. At this time, the retrieval may be performed based on the code description or the code itself.

In an example, in operation 320, the electronic device may retrieve a similar code to the coding query from a DB storing one or more codes and respective code descriptions for the one or more codes.

In an example, the electronic device may vectorize the coding query input by the user and compare the coding query with the codes or the code descriptions stored in the DB. Vectorization may be a task of transforming data into the same vector space so as to calculate a similarity between a coding query and a stored code or code description. For example, when the user inputs a coding query such as “Code for processing a user login process,” the electronic device may vectorize the coding query and calculate a similarity with the codes or the code descriptions stored in the DB.

The electronic device may use various mathematical methods to evaluate the similarity between the coding query and the code description stored in the DB. Using the dot product similarity method, the similarity may be calculated based on vector representations of the coding query and the code description. The dot product considers both a magnitude and a direction of a vector, and thus, it may be useful to evaluate relevance of the coding query and the code description in a case where the magnitude is important.

For example, when the user inputs a “Code for a user authentication system” and requests a description thereof, the electronic device may vectorize the coding query and retrieve a description with a highest similarity by calculating the dot product with a code description vector stored in the DB.

The dot product may help the retriever efficiently calculate the similarity between the coding query and the code description in the DB. In addition, it may be used with cosine similarity to contribute to evaluation of the similarity more accurately. This may allow the electronic device to retrieve an accurate and highly relevant code description that matches a user query and use the code description as input data.

The electronic device may evaluate whether the retrieved code or code description is semantically related to the coding query. When the retrieved code or code description matches the intent of the coding query, the code or code description may be selected with priority. For example, when the coding query is “Processing user login,” “Code description and code for processing user authentication procedures” may have a high similarity.

In an example, in operation 330, an electronic device (e.g., electronic device 500) may generate input data based on at least one of the similar code or a code description corresponding to the similar code.

In an example, the electronic device may form the input data by combining the code query (or the rewritten NL code query), and the retrieved code and code description. The retrieved code may be used as reference material for the code description generation task, and the code description may be used to specifically provide a functional background and operational intent of the code. For example, when the user inputs a coding query such as “User authentication process code,” the electronic device may form the input data by combining “Existing code related to user authentication” in addition to “Description of code that verifies user input and verifies qualification in the DB.”

When forming the input data, the electronic device may generate the input data by utilizing only the retrieved code even if the retrieved code description does not exist. In this case, even if the code description is lacking, a suitable code description may be generated by analyzing the operation characteristics and structural elements of the code. For example, when the retrieved code is “Algorithm code for encrypting a user password,” the electronic device may generate a description such as “Description of encryption algorithm code for securing user data” based on this.

In an example, the electronic device may be configured to include the coding query of the user in the input data so that the code LLM considers the retrieved code and description together with the intent of the user. For example, the input data may be formed in a format such as “Query: User authentication process code, Retrieved code: [Code description], Description: User input verification and Session generation.”

The electronic device may generate efficient and concise input data by removing unnecessary information and duplicate data during the process of forming the input data. Through this, the code LLM may generate a final code description that reflects the request of the user more accurately by using the information about the retrieved code and code description.

In an example, in operation 340, an electronic device (e.g., electronic device 500) may generate a final code description based on the input data.

In an example, the electronic device may generate a final code description by extending or transforming the input data to correspond to the coding query. That is, in an example, the final code may be generated by modifying the input data correspond to the coding query.

In an example, the electronic device may analyze the input data using a code description LLM and generate a specific final code description by combining contextual information of the retrieved code and description included in the input data. For example, when the user inputs the coding query such as “User authentication process code,” the electronic device may generate a final code description such as “Process of verifying a user input, verifying qualification in a DB, and initializing a session” based on the retrieved code and description.

In an example, the electronic device may perform code description generation through the code description LLM. The electronic device may access a cloud-based LLM through a network or perform code description by using an LLM implemented in an on-device form on the electronic device 500.

In an example, the electronic device may verify whether the generated final code description matches the coding query of the user. In the verification process, the electronic device may confirm whether the generated description matches the request of the user and matches the operation characteristics of the retrieved code. For example, it may be evaluated whether the generated code description matches the user query in terms of “performing user authentication and session initialization during the login procedure.”

The verification may be performed using a lightweight verification model or an additional language model. The generated code description may be compared with an existing code description to evaluate contextual relevance and accuracy, or may verify expected results with example data.

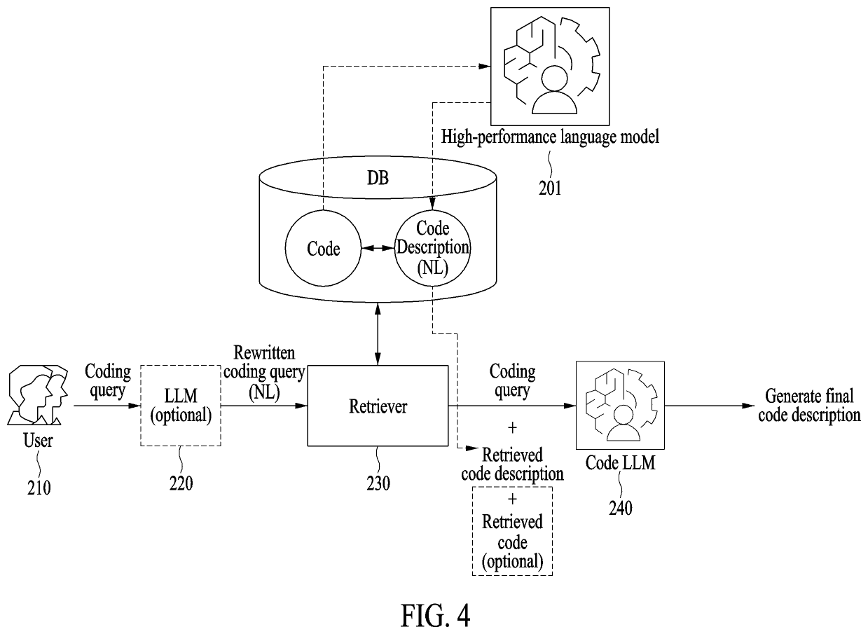

FIG. 4 illustrates an example method of enhancing code description retrieval according to one or more embodiments.

The description provided with reference to FIGS. 1 to 3 may apply to FIG. 4, and any repeated description related thereto may be omitted.

Referring to FIG. 4, in a non-limiting example, the user 210 may input a coding query requesting a description of a function or operation of the code. The coding query input by the user 210 may be transformed into an NL-based code description query through the LLM 220. The LLM 220 may analyze the contextual characteristics and intent of the input code query and generate an NL coding query rewritten in a form that may be processed by the retriever 230. For example, when the user requests “Description of a code for processing user authentication process,” the LLM 220 may transform it into an NL description, such as “This code performs functions of verifying the user input, verifying qualification in the DB, and initializing a session.”

The retriever 230 may retrieve a suitable code description and code (Snippet) from the DB using a coding query input by the user or a rewritten NL coding query provided by the LLM 220. The DB may include pairs of the code and the code description generated using the high-performance language model (e.g., LLM) 201, for example, Llama3.1-405B. The high-performance language model (e.g., LLM) 201 may analyze the code (e.g., Snippet) in the DB and generate an NL-based description that reflects the operation characteristics and contextual meaning of the code to form a pair (code and code description).

The retriever 230 may perform the vectorization process to calculate the similarity between the coding query and the code description in the DB. Vectorization may be a process of transforming data so as to compare a coding query and a stored code or code description in the same vector space. For example, when the user requests “Description of a code for processing user authentication process,” the retriever 230 may vectorize this query, compare the query with the code descriptions stored in the DB, and retrieve most suitable description and code.

At least one of the retrieved code description and code may be combined as the input data and transmitted to the code LLM 240. For example, the input data may be formed in a format such as “Query: User authentication process code description, Retrieved code: [Code description], Description: User input verification and Session generation.” The input data may remove unnecessary information and may be arranged concisely to support efficient code description generation.

In an example, the code LLM 240 may generate a final code description corresponding to the coding query of the user based on the input data. For example, a specific and clear description such as “Process of verifying a user input, verifying qualification in a DB, and initializing a session when successfully authenticated” may be generated according to the user query.

The finally generated code description may be subjected to a verification process. The electronic device may evaluate whether the generated code description matches the user query and the retrieved code. The verification may be performed using a lightweight verification model or an additional language model, and the contextual relevance and accuracy may be confirmed.

FIG. 5 illustrates an example electronic device according to one or more embodiments.

The description provided with reference to FIGS. 1 to 4 may apply to FIG. 5, and any repeated description related thereto may be omitted.

Referring to FIG. 5, in a non-limiting example, an electronic device 500 may include a processor 530, a memory 550, and an output device 570 (e.g., a display). The processor 530, the memory 550, and the output device 570 may be connected to one another via a communication bus 505. The electronic device 500 may include the processor 530 for performing the at least one method described above or an algorithm corresponding to the at least one method, for operating the electronic device 500.

The output device 570 may display a user interface for the retrieval of a code or a code description performed by the processor 530. The output device 570 may be the same device as the display included in the electronic device 500. In addition, the output device 570 may be embedded in the electronic device 500 to display the user interface or may be an external display device.

The memory 550 may include computer-readable instructions. The processor 530 may be configured to execute computer-readable instructions, such as those stored in the memory 550, and through execution of the computer-readable instructions, the processor 530 is configured to perform one or more, or any combination, of the operations and/or methods described herein. The memory 550 may be a volatile or nonvolatile memory.

The processor 530 may be configured to execute programs or applications to configure the processor 530 to control the electronic apparatus 1200 to perform one or more or all operations and/or methods involving the resolution of a deadlock state and resuming a task, and may include any one or a combination of two or more of, for example, a central processing unit (CPU), a graphic processing unit (GPU), a neural processing unit (NPU) and tensor processing units (TPUs), but is not limited to the above-described examples.

Also, the processor 530 may perform one or more of the methods described with reference to FIGS. 1 to 4, or an algorithm corresponding to the one or more of the methods. In the above-described process, the processor 530 may be a data processing device embodied by hardware having a circuit of a physical structure to execute desired operations.

The electronic devices, processors, memories, neural networks, LLM 220, Retriever 230, Code LLM 240, electronic device 500, processor 530, memory 550, and output device 570 described herein and disclosed herein described with respect to FIGS. 1-5 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
receiving a natural language (NL) query;
retrieving a similar code similar to the NL query from a database (DB) storing one or more codes and respective code descriptions for the one or more codes;
generating input data based on one or more of the similar code and a code description corresponding to the similar code; and
generating a final code based on the input data.

2. The method of claim 1, wherein the one or more codes and the respective code descriptions for the one or more codes are aligned according to one of operation characteristics and a structural similarity of a corresponding code.

3. The method of claim 1, wherein the retrieving of the similar code comprises:
retrieving a suitable code description by calculating similarities between a vectorized NL query and the respective code descriptions.

4. The method of claim 3, further comprising:
evaluating a semantic relationship between the suitable code description and the NL query.

5. The method of claim 1, wherein the generating of the final code comprises:
generating a code obtained by extending or transforming the input data to correspond to the NL query.

6. The method of claim 1, further comprising:
performing verification for the NL query, the input data, and the final code.

7. The method of claim 1, wherein the respective code descriptions for the one or more codes are generated using a large language model (LLM) to be matched with the one or more codes as a pair.

8. The method of claim 7, wherein the LLM is trained to generate an NL-based description, the NL-based description reflecting a result of analyzing contextual characteristics of a code.

9. The method of claim 1, wherein the receiving of the NL query comprises:
rewriting the NL query in a form understandable by a retriever based on an LLM.

10. A processor-implemented method, the method comprising:
receiving a coding query generated based on a code input;
retrieving a similar code similar to the coding query from a database (DB) storing one or more codes and respective code descriptions for the one or more codes;
generating input data based one or more of the similar code and a code description corresponding to the similar code; and
generating a final code description based on the input data.

11. The method of claim 10, wherein the receiving of the generated coding query comprises:
rewriting the code input into a form comprehensible to a retriever based on a large language model (LLM).

12. The method of claim 10, wherein the generating of the final code description comprises:
generating a code description obtained by modifying the input data to correspond to the coding query.

13. An electronic device, comprising:
a processor configured to execute instructions; and
a memory storing the instructions, wherein execution of the instructions configures the processor to:
receive a natural language (NL) query;
retrieve a similar code similar to the NL query from a database (DB) storing one or more codes and respective code descriptions for the one or more codes;
generate input data based on at least one of the similar code or a code description corresponding to the similar code; and
generate a final code based on the input data.

14. The electronic device of claim 13, further comprising:
an output device configured to display an interface related to code retrieval to receive the NL query.

15. The electronic device of claim 13, wherein the processor is further configured to:
retrieve a suitable code description by calculating similarities between a vectorized NL query and the respective code descriptions, and
wherein the one or more codes and the respective code descriptions for the one or more codes are aligned according to one or more of operation characteristics and a structural similarity of a corresponding code.

16. The electronic device of claim 15, wherein the processor is further configured to:
evaluate a semantic relationship between the suitable code description and the NL query.

17. The electronic device of claim 13, wherein the processor is further configured to:
generate a code obtained by modifying the input data to correspond to the NL query.

18. The electronic device of claim 13, wherein the processor is further configured to:
perform verification for the NL query, the input data, and the final code.

19. The electronic device of claim 13, wherein the respective code descriptions for the one or more codes are generated using a large language model (LLM) to be matched with the one or more codes as a pair.

20. The electronic device of claim 19, wherein the LLM is trained to generate an NL-based description, NL-based description reflecting a result of analyzing contextual characteristics of a code.
